(19) United States
(12) Patent Application Publication
(10) Pub. No.: US 2016/0097428 A1
(43) Pub. Date: Apr. 7, 2016

(54) TRANSMISSION SYSTEM HAVING A SLIDER VALVE

(71) Applicant: Caterpillar Inc., Peoria, IL (US)

(72) Inventor: Glen P. Calvert, Washington, IL (US)

(73) Assignee: Caterpillar Inc., Peoria, IL (US)

(21) Appl. No.: 14/506,904

(22) Filed: Oct. 6, 2014

(51) Int. Cl. F16D 25/06; F16D 25/12

(52) U.S. Cl. CPC F16D 25/06; F16D 25/123

(57) ABSTRACT

A transmission system including a clutch pack, a piston to engage and disengage the clutch pack, a lube oil passage to transmit lube oil, a clutch fluid passage to transmit clutch fluid, and a slider valve infinitely movable between an open position and a closed position and in fluid communication with the lube oil passage and the clutch fluid passage. In the open position, the slider valve allows lube oil to flow from the lube oil passage to the clutch pack, and in the closed position, the slider valve prevents lube oil from flowing from the lube oil passage to the clutch pack. When the piston engages the clutch pack, the piston pushes the slider valve to be in the open position, and when the piston disengages the clutch pack, the slider valve remains in the open position based on pressure by the clutch fluid on the slider valve.

### TECHNICAL FIELD

The present disclosure relates generally to a transmission system and more specifically a transmission system having a slider valve.

### BACKGROUND

In a transmission system, a clutch may include one or more clutch plates which can be cooled by lube oil. However, too much lube oil can cause inefficiencies in the transmission system, while too little lube oil can cause the clutch plates to have a high temperature. The high temperature can cause an increased amount of wear on the clutch plates.

In U.S. Pat. No. 6,098,771 to Vu (“'771 Patent”) A clutch is disclosed including at least one fixed member, at least one clutch plate movable between engaged and disengaged positions, a housing about the clutch plate, a piston to move the clutch plate, a pressurized fluid supply to the piston, a passage through the piston, and a valve member located proximate the passage for opening and at least partially closing the passage.

However, in the '771 Patent an undesirable amount of fluid may reach the clutch plate. That is, too much or too little fluid may reach the clutch plate.

The system and method of the present disclosure solves one or more problems set forth above and/or other problems in the art.

### SUMMARY

In one aspect, the present disclosure is directed to a transmission system including a clutch pack, a piston configured to engage and disengage the clutch pack, a lube oil passage configured to transmit lube oil, a clutch fluid passage configured to transmit clutch fluid, and a slider valve infinitely movable between an open position and a closed position and in fluid communication with the lube oil passage and the clutch fluid passage. In the open position, the slider valve allows lube oil to flow from the lube oil passage to the clutch pack, and in the closed position, the slider valve prevents lube oil from flowing from the lube oil passage to the clutch pack. Furthermore, when the piston engages the clutch pack, the piston pushes the slider valve to be in the open position, and when the piston disengages the clutch pack, the slider valve is configured to remain in the open position based on pressure by the clutch fluid on the slider valve.

In another aspect, the present disclosure is directed a method for operating a transmission system including engaging the clutch pack using a piston, pushing a slider valve to be in an open position using the piston, disengaging the clutch pack using the piston, keeping the slider valve in the open position based on pressure by clutch fluid on the slider valve, allowing lube oil to flow from a lube oil passage to the clutch pack when the slider valve is in the open position, and preventing lube oil from flowing from the lube oil passage to the clutch pack when the slider valve is in a closed position.

In another aspect, the present disclosure is directed to a machine including an engine configured to provide rotational power and a transmission system configured to receive the rotational power from the engine. The transmission system can include a clutch pack, a piston configured to engage and disengage the clutch pack, a lube oil passage configured to transmit lube oil, a clutch fluid passage configured to transmit clutch fluid, and a slider valve infinitely movable between an open position and a closed position and in fluid communication with the lube oil passage and the clutch fluid passage. In the open position, the slider valve allows lube oil to flow from the lube oil passage to the clutch pack, and in the closed position, the slider valve prevents lube oil from flowing from the lube oil passage to the clutch pack. Furthermore, when the piston engages the clutch pack, the piston pushes the slider valve to be in the open position, and when the piston disengages the clutch pack, the slider valve is configured to remain in the open position based on pressure by the clutch fluid on the slider valve.

### BRIEF DESCRIPTION OF THE DRAWINGS

FIG. 1 depicts a machine according to an embodiment;

FIG. 2 depicts a transmission system according to an embodiment;

FIG. 3 depicts a transmission unit according to an embodiment;

FIG. 4 depicts a portion of a clutch in a transmission unit with a slider valve in a closed position according to an embodiment;

FIG. 5 depicts a portion of a clutch in a transmission unit with a piston engaging a clutch pack and a slider valve in an open position according to an embodiment;

FIG. 6 depicts a portion of a clutch in a transmission unit with a piston disengaged from a clutch pack and a slider valve in an open position according to an embodiment; and

FIG. 7 depicts a process for operating a transmission system according to an embodiment.

### DETAILED DESCRIPTION

FIG. 1 depicts a machine 100 comprising a transmission system 102 and an engine 138. In FIG. 1, the machine 100 comprises a motor grader. However, in alternate embodiments, the machine 100 can comprise a track-type tractor, a wheel loader, a haul truck, a large mining truck, an off-highway truck, and the like. The machine 100 can also comprise machines, which utilize transmissions systems similar to the transmission system 102. Furthermore, the machine 100 may embody any wheeled or tracked machine associated with mining, agriculture, forestry, construction, and other industrial applications. The engine 138 can be configured to provide rotational power and the transmission system 102 can be configured to receive the rotational power from the engine 138.

The engine 138 may be an internal combustion engine such as, for example, a reciprocating piston engine or a gas turbine engine. In an embodiment, the engine 138 comprises a spark ignition engine or a compression ignition engine. The compression ignition engine can be, for example, a diesel engine, a homogeneous charge compression ignition engine, or a reactivity controlled compression ignition engine.

The engine 138 can also comprise other compression ignition engine known in the art. In an embodiment, the engine 138 may be fueled by diesel, fuel that contains water, or fuel that needs water removed.

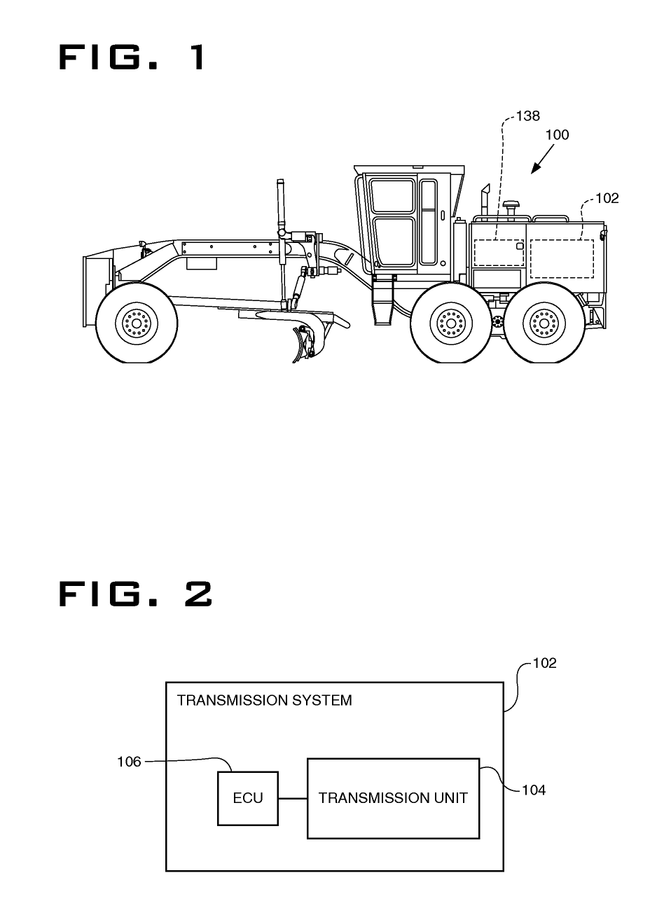

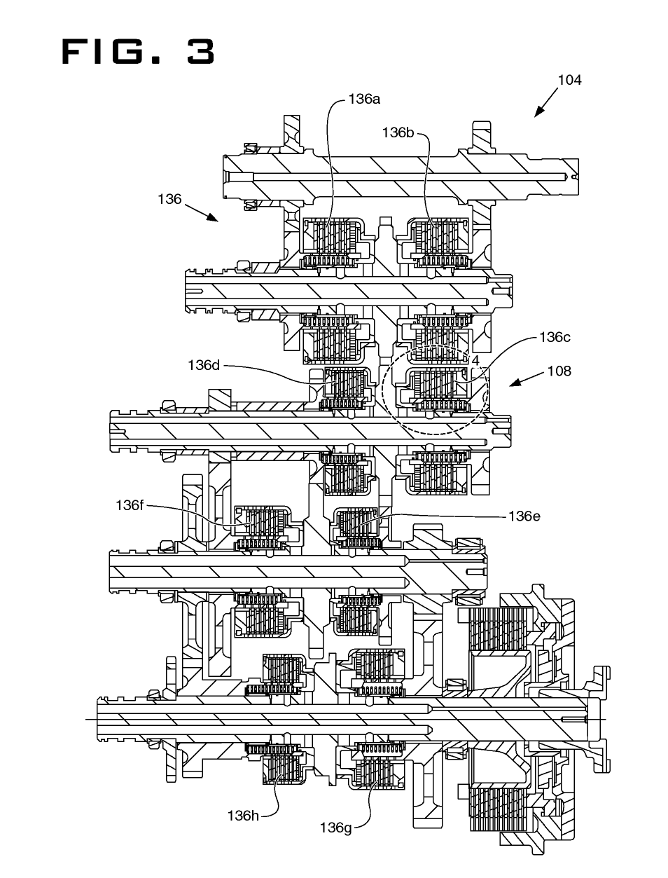

As seen in FIG. 2, the transmission system 102 can comprise a transmission unit 104 and an electronic control unit (“ECU”) 106. The ECU can control one or more operations of the transmission unit 104, which will be described in more detail later. In an embodiment, the ECU 106 comprises a clutch logic. The transmission unit 104 can be seen in more detail in FIG. 3.

As shown in FIG. 3, the transmission unit 104 can comprise a plurality of clutches 136 such as the clutches 136a-136h. The clutches 136a-136h can be utilized during different speeds of the machine and even for different directions of travel of the machine 100. In an embodiment, the transmission unit 104 can comprise a countershaft transmission.

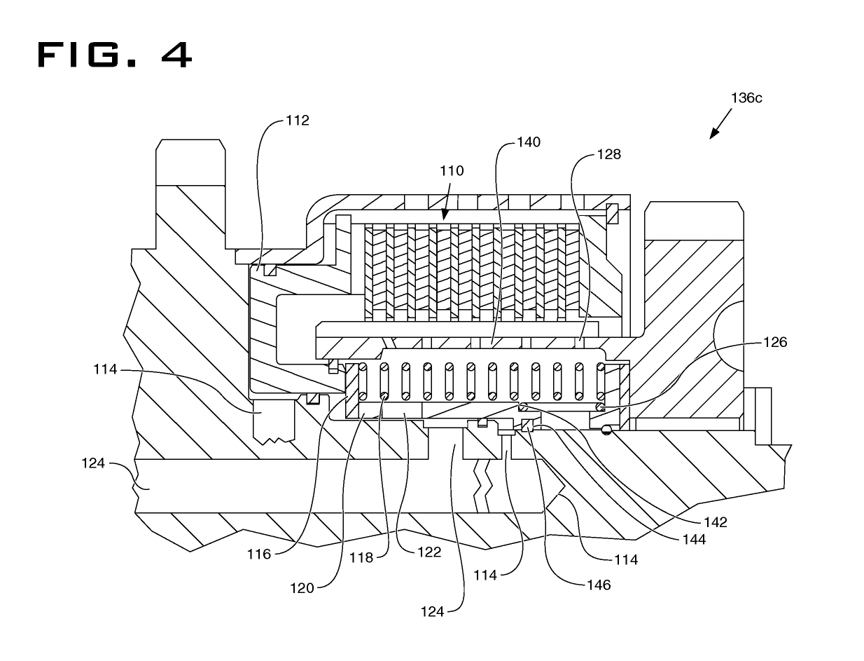

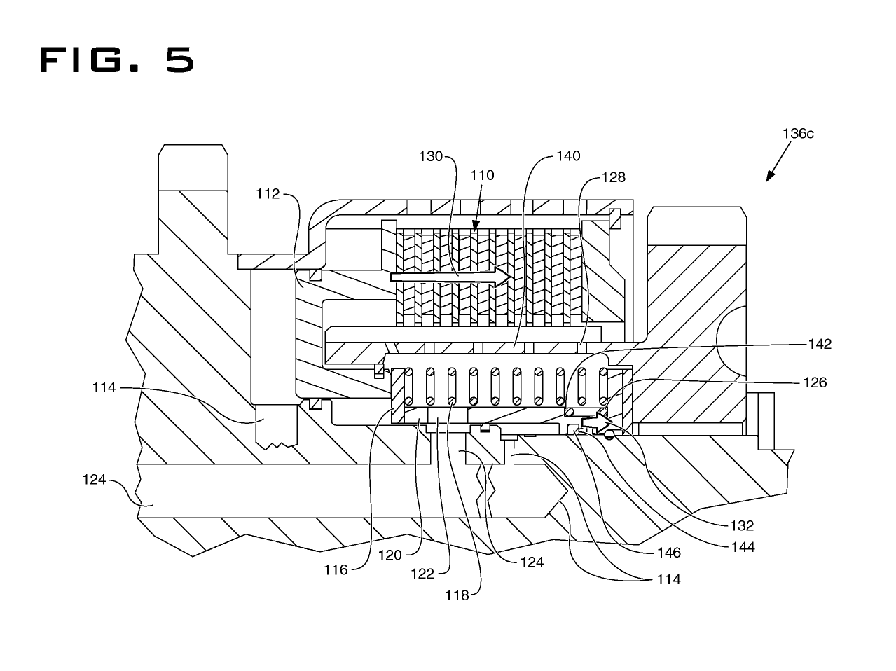

A portion of the clutch 136c in FIG. 3 can be seen in FIG. 4 as indicated by the section 108. As shown in FIG. 4, the clutch 136c can comprise a clutch pack 110 which can be engaged by a piston 112. The clutch pack 110 can comprise one or more clutch disks and plates. The clutch disks and plates are slidably movable in a longitudinal direction by the piston 112 when the piston 112 engages the clutch pack 110. The piston 112 can be connected to a clutch fluid passage 114 to receive clutch fluid.

The clutch fluid can aid in actuating the piston 112 to engage or disengage the clutch pack 110. That is, as pressure by the clutch fluid is increased, the piston 112 can move towards and engage the clutch pack 110. Similarly, as the pressure by the clutch fluid is decreased, the piston 112 can move away from and disengage the clutch pack 110. In an embodiment, the clutch fluid can comprise clutch oil.

The piston 112 can also be configured to contact a piston plate 116. The piston plate 116 is configured to be biased towards the piston 112 by a piston retraction spring 118. The piston plate 116 is also configured to transfer force from the piston 112 to a slider valve 120 when the piston 112 engages the clutch pack 110. The slider valve 120 is configured to be infinitely moveable between an open position and a closed position, which will be described in more detail below. The slider valve 120 is also in fluid communication with a lube oil passage 124 and the clutch fluid passage 114. In FIG. 4, the lube oil passage 124 and the fluid passage 114 are spaced apart in the shaft and the broken lines depict that the passages are not connected to another. However, they are shown adjacent one another in the interest of brevity.

The slider valve 120 can also define an aperture 122, which is configured to be at least partially aligned with the lube oil passage 124 when the slider valve 120 is in the open position. In such a case, the lube oil from the lube oil passage 124 can flow through the aperture 122. Subsequently, the lube oil can also flow through apertures 128 defined by a hub 140 onto the clutch pack 110. The hub 140 can partially enclose the slider valve retraction spring 126 and the slider valve 120.

The slider valve 120 can also comprise a first end and a second end opposite the first end. The aperture 122 can be located at or near the first end of the slider valve 120, while the slider valve retraction spring 126 can contact the slider valve 120 at or near the second end of the slider valve 120. Furthermore, the aperture 122 can face a direction substantially perpendicular to a direction in which the slider valve 120 slides.

The slider valve 120 can also define a slot 142 and a slot 144. In an embodiment, the slots 142 and 144 can each comprise an annulus. The slider valve retraction spring 126 can contact the slider valve 120 at the slot 142. A seal 146 can be located within the slot 142. The seal 146 can be configured to prevent clutch fluid from the clutch fluid passage 114 from entering past the seal 146. The seal 146 can comprise a rubber seal, which moves along with the slider valve 120.

When the slider valve 120 is in the closed position, the aperture 122 is not aligned with the lube oil passage 124. In such a case, the slider valve 120 prevents the lube oil from the lube oil passage 124 from flowing to the clutch pack 110.

In addition to the pressure supplied by the piston 112 and the piston plate 116, the slider valve 120 can also be in an open or closed position based on the pressure by the clutch fluid, which will be described in more detail below. The pressure by the clutch fluid can be controlled by the ECU 106. For example, the ECU 106 can increase or decrease pressure by the clutch fluid.

### INDUSTRIAL APPLICABILITY

By using the slider valve 120 and additional supporting components disclosed above, the clutch pack 110 can receive additional lube oil, even when the piston 112 is disengaged from the clutch pack 110. This allows the clutch pack 110 to be cooled by the lube oil for an additional period of time, which can result in a lower temperature of the clutch pack 110. This can increase a longevity of the clutch pack 110. For example, longevity of friction material in the clutch pack 110 can be increased when temperature in the clutch pack 110 is decreased.

Furthermore, the period of time where the lube oil is cooling the clutch pack 110 and the quantity of lube oil that is cooling the clutch pack 110 can be adjusted by the ECU 106 to further customize how long the clutch pack 110 should be cooled. This can reduce drag losses and increase efficiency since prolonged use of the lube oil to cool the clutch pack can increase drag and decrease efficiency.

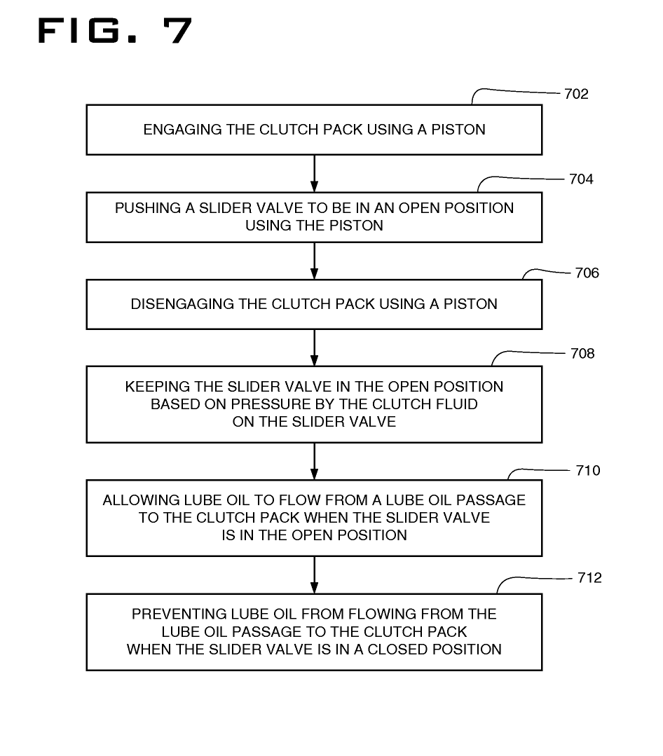

In an embodiment, a method for operating the transmission system 102 is shown in FIG. 7. In block 702, the clutch pack 110 is engaged using the piston 112. For example, when the pressure by the clutch fluid is greater than a first predetermined pressure threshold, the piston 112 can engage the clutch pack 110. This can be seen in FIG. 5 with movement of the piston 112 indicated by the arrow 130. In an embodiment, the pressure by the clutch fluid can comprise approximately 350 pounds per square inch (“PSI”). However, other amounts of pressure by the clutch fluid may also be utilized.

In block 704, the slider valve 120 is pushed to be in an open position using the piston 112. For example, the slider valve 120 moves longitudinally as indicated by the arrow 132. Furthermore, as shown in FIG. 5, the aperture 122 is aligned or partially aligned with the lube oil passage 124 to allow lube oil to flow through to the clutch pack 110.

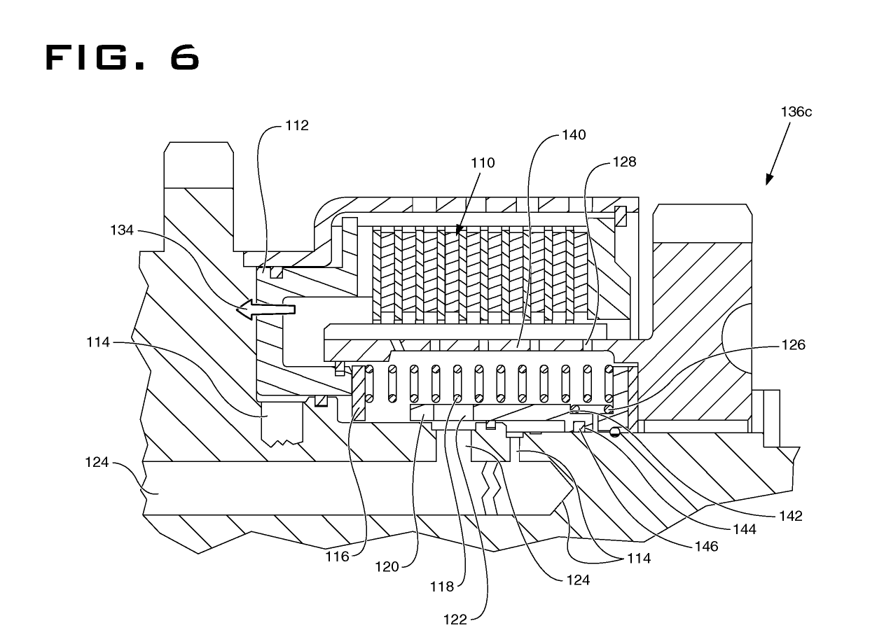

In block 706, the clutch pack 110 is disengaged by the piston 112. For example, when the pressure by the clutch fluid is not greater than the first predetermined pressure threshold, the piston 112 can disengage the clutch pack 110. This can be seen in FIG. 6 with movement of the piston 112 indicated by the arrow 134.

In block 708, the slider valve 120 is kept in the open position based on pressure by the clutch fluid on the slider valve 120. For example, the slider valve 120 can be kept in the open position when the pressure by the clutch fluid is greater than a second predetermined pressure threshold, but not greater than the first predetermined pressure threshold.

The second predetermined pressure threshold can be less than the first predetermined pressure threshold. In an embodiment, the second predetermined pressure threshold can correspond with an amount of pressure necessary to overcome or partially overcome a bias provided by the slider valve retraction spring 126 on the slider valve 120. As previously noted, the slider valve retraction spring 126 biases the slider valve 120 towards the closed position. For example, the second predetermined pressure threshold can correspond with a spring constant of the slider valve retraction spring 126.

Thus, the pressure by the clutch fluid can be decreased such that the piston 112 returns to its original position, but the slider valve 120 remains in an open position. That is, the pressure by the clutch fluid is insufficient to overcome the bias provided by the piston retraction spring 118, but sufficient to overcome the bias provided by the slider valve retraction spring 126. Thus, since the piston plate 116 is separate from the slider valve 120, the piston plate 116 and the piston 112 will return to its original position, while the slider valve 120 remains in an open position. Therefore, a spring constant of the piston retraction spring 118 can be greater than the spring constant of the slider valve retraction spring 126.

In an embodiment, the pressure by the clutch fluid comprises between approximately 10 PSI to 15 PSI. However, other amounts of pressure by the clutch fluid can also be utilized to maintain the slider valve 120 in the open position.

Furthermore, in an embodiment, when the piston 112 disengages the clutch pack 110, the alignment of the aperture 122 with the lube oil passage 124 is based on the pressure by the clutch fluid on the slider valve 120. For example, the aperture 122 need not be completely aligned with the lube oil passage 124. Instead, the aperture 122 can be partially aligned with the lube oil passage 124 to allow more or less lube oil through the aperture 122. The alignment of the aperture 122 with the lube oil passage 124 can correspond to the amount of pressure by the clutch fluid on the slider valve 120.

In an embodiment, the ECU 106 can control the amount and the flow rate of lube oil that the clutch pack 110 receives by controlling the pressure of the clutch fluid. Also, the seal 146 can prevent the clutch fluid from entering unwanted areas while still permitting the slider valve 120 to move between an open position and a closed position.

In block 710, lube oil is allowed to flow from the lube oil passage 124 to the clutch pack 110 when the slider valve 120 is in the open position. For example, the lube oil can flow from the lube oil passage 124 through the aperture 122. The lube oil can then flow through the apertures 128 to the clutch pack 110.

In block 712, lube oil is prevented from flowing from the lube oil passage 124 to the clutch pack 110 when the slider valve 120 is in the closed position. For example, the slider valve 120 can be moved into the closed position when the pressure by the clutch fluid is not greater than the second predetermined pressure threshold. This can be seen, for example, in FIG. 4 where the slider valve 120 returns to the closed position.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims.

What is claimed is:

1. A transmission system comprising:
a clutch pack;
a piston configured to engage and disengage the clutch pack;
a lube oil passage configured to transmit lube oil;
a clutch fluid passage configured to transmit clutch fluid;
a slider valve infinitely movable between an open position and a closed position and in fluid communication with the lube oil passage and the clutch fluid passage,
wherein in the open position, the slider valve allows lube oil to flow from the lube oil passage to the clutch pack, and in the closed position, the slider valve prevents lube oil from flowing from the lube oil passage to the clutch pack, and
wherein when the piston engages the clutch pack, the piston pushes the slider valve to be in the open position, and when the piston disengages the clutch pack, the slider valve is configured to remain in the open position based on pressure by the clutch fluid on the slider valve.

2. The transmission system of claim 1 further comprising a slider valve retraction spring configured to bias the slider valve to be in the closed position, and wherein the slider valve is configured to remain in the open position when the pressure by the clutch fluid on the slider valve is sufficient to overcome the bias provided by the slider valve retraction spring.

3. The transmission system of claim 2 further comprising
a piston plate separate from the slider valve, and located between the piston and the slider valve; and
a piston retraction spring configured to bias the piston plate towards the piston, wherein the piston plate is configured to transfer force from the piston to the slider valve when the piston engages the clutch pack.

4. The transmission system of claim 1 wherein the piston is configured to be connected to the clutch fluid passage, to engage the clutch pack when the pressure by the clutch fluid is greater than a first predetermined pressure threshold, and to disengage the clutch pack when the pressure by the clutch fluid is not greater than the first predetermined pressure threshold.

5. The transmission system of claim 4 wherein the slider valve is configured to remain in the open position when the pressure by the clutch fluid is greater than a second predetermined pressure threshold, but not greater than the first predetermined pressure threshold, wherein the second predetermined pressure threshold is less than the first predetermined pressure threshold.

6. The transmission system of claim 5 wherein the slider valve is configured to be in the closed position when the pressure by the clutch fluid is not greater than the second predetermined pressure threshold.

7. The transmission system of claim 1 wherein the slider valve defines an aperture, which is configured to be at least partially aligned with the lube oil passage when the slider valve is in the open position.

8. The transmission system of claim 7 wherein when the piston disengages the clutch pack, alignment of the aperture with the lube oil passage is based on pressure by the clutch fluid on the slider valve.

9. The transmission system of claim 1 wherein when the piston disengages the clutch pack, a flow rate of the lube oil from the lube oil passage to the clutch pack is based at least partially on the pressure by the clutch fluid on the slider valve.

10. The transmission system of claim 1 further comprising an electronic control unit (“ECU”) configured to control the pressure by the clutch fluid on the slider valve.

11. A method for operating a transmission system comprising:
engaging the clutch pack using a piston;
pushing a slider valve to be in an open position using the piston;
disengaging the clutch pack using the piston;
keeping the slider valve in the open position based on pressure by clutch fluid on the slider valve;
allowing lube oil to flow from a lube oil passage to the clutch pack when the slider valve is in the open position; and
preventing lube oil from flowing from the lube oil passage to the clutch pack when the slider valve is in a closed position.

12. The method of claim 11 further comprising keeping the slider valve in the open position when the pressure by the clutch fluid on the slider valve is sufficient to overcome a bias provided by a slider valve retraction spring on the slider valve.

13. The method of claim 12 further comprising biasing a piston plate towards the piston using a piston retraction spring, wherein the piston plate is separate from the slider valve, and located between the piston and the slider valve.

14. The method of claim 11 further comprising:
engaging the clutch pack using the piston when the pressure by the clutch fluid is greater than a first predetermined pressure threshold; and
disengaging the clutch pack using the piston when the pressure by the clutch fluid is not greater than the first predetermined pressure threshold.

15. The method of claim 14 further comprising:
keeping the slider valve in the open position when the pressure by the clutch fluid is greater than a second predetermined pressure threshold, but not greater than the first predetermined pressure threshold, wherein the second predetermined pressure threshold is less than the first predetermined pressure threshold.

16. The method of claim 15 further comprising moving the slider valve into the closed position when the pressure by the clutch fluid is not greater than the second predetermined pressure threshold.

17. A machine comprising:
an engine configured to provide rotational power;
a transmission system configured to receive the rotational power from the engine, the transmission system comprising:
a clutch pack;
a piston configured to engage and disengage the clutch pack;
a lube oil passage configured to transmit lube oil;
a clutch fluid passage configured to transmit clutch fluid;
a slider valve infinitely movable between an open position and a closed position and in fluid communication with the lube oil passage and the clutch fluid passage,
wherein in the open position, the slider valve allows lube oil to flow from the lube oil passage to the clutch pack, and in the closed position, the slider valve prevents lube oil from flowing from the lube oil passage to the clutch pack, and
wherein when the piston engages the clutch pack, the piston pushes the slider valve to be in the open position, and when the piston disengages the clutch pack, the slider valve is configured to remain in the open position based on pressure by the clutch fluid on the slider valve.

18. The machine of claim 17 wherein the transmission system further comprises a slider valve retraction spring configured to bias the slider valve to be in the closed position, and wherein the slider valve is configured to remain in the open position when the pressure by the clutch fluid on the slider valve is sufficient to overcome the bias provided by the slider valve retraction spring.

19. The machine of claim 17 wherein the transmission system further comprises
a piston plate separate from the slider valve, and located between the piston and the slider valve; and
a piston retraction spring configured to bias the piston plate towards the piston, wherein the piston plate is configured to transfer force from the piston to the slider valve when the piston engages the clutch pack.

20. The machine of claim 17 wherein the transmission system further comprises an electronic control unit (“ECU”) configured to control the pressure by the clutch fluid on the slider valve.
